(19) United States
(12) Patent Application Publication
(10) Pub. No.: US 2017/0050540 A1
(43) Pub. Date: Feb. 23, 2017

(54) MOUNTING ARRANGEMENT FOR SEAT OF MACHINE

(71) Applicant: Caterpillar Inc., Peoria, IL (US)

(72) Inventors: Nathan D. French, Metamora, IL (US); Jonathan C. Catton, Brimfield, IL (US); Ryan B. Hausauer, Chillicothe, IL (US)

(73) Assignee: Caterpillar Inc., Peoria, IL (US)

(21) Appl. No.: 15/345,230

(22) Filed: Nov. 7, 2016

(51) Int. Cl. B60N 2/07; B60N 2/06; B25J 5/06; B60N 2/38

(52) U.S. Cl. CPC B60N 2/0735; B60N 2/38; B60N 2/0732; B60N 2/062; B25J 5/06

(57) ABSTRACT

A mounting arrangement for a seat of a machine is disclosed. The mounting arrangement includes a first plate adapted to couple to a support member of the seat. The mounting arrangement includes a second plate slidably coupled to the first plate. The mounting arrangement includes a first pair of rails disposed between the first plate and the second plate. The first pair of rails includes a first rail disposed at a first predefined distance and a second rail disposed at a second predefined distance with respect to a central axis of the seat. The mounting arrangement further includes a second pair of rails disposed between the first plate and the second plate. The second pair of rails includes a third rail disposed at a third predefined distance with respect to the central axis and a fourth rail disposed at a fourth predefined distance with respect to the central axis.

### TECHNICAL FIELD

The present disclosure relates to a seat, and more particularly relates to a mounting arrangement for the seat of a machine.

### BACKGROUND

Machines, such as large wheel loaders, include an operator cabin having an operator interface, such as an accelerator, a braking pedal, a steering wheel, and a display device, for controlling operation of the machine. The operator cabin further includes a seat and various controls mounted on sides of the seat. A seat pan of the seat is coupled to a suspension member, which is in turn mounted on a floor of the operator cabin. The coupling between the seat pan and the suspension member includes a pair of rails for enabling sliding movement of the seat. Typically, weight of the seat and the controls mounted on the seat cause wear and tear on the rails of the base, over a period of time. Conventional mounting arrangement of the seat fails to evenly distribute load acting on the base, which further leads to premature failure of various components of the base. Additionally, the load acting on the base causes rigidity relating to the sliding movement of the seat in a forward direction or a backward direction.

Chinese Patent Publication Number 204236271, hereinafter referred to as ‘the '271 publication’, describes a utility model with a car seat chassis rail bracket. The car seat chassis rail bracket includes a set of inverted trapezoidal support frame and a mobile frame. The top surface of the support frame is provided with a central opening in the first bracket and vertical openings at both ends, which is bent downward to form a bending angle of the support frame. A lower portion of barbs are provided with a plurality of arc-shaped connecting member for providing the recess. The recess is provided with a plurality of spherical balls. However, the '271 publication fails to disclose an arrangement that provides efficient distribution of weight of the seat on the support frame.

### SUMMARY OF THE DISCLOSURE

In an aspect of the present disclosure, a mounting arrangement for a seat of a machine is provided. The mounting arrangement includes a first plate adapted to couple to a support member of the seat. The support member is mounted on a floor panel of the machine. The mounting arrangement further includes a second plate slidably coupled to the first plate. The second plate includes a plurality of mounting members adapted to couple to a seat pan and multiple control devices disposed adjacent to the seat pan. The mounting arrangement further includes a first pair of rails disposed between the first plate and the second plate proximal to a first peripheral edge of each of the first plate and the second plate. The first pair of rails includes a first rail disposed at a first predefined distance with respect to a central axis of the seat. The first pair of rails further includes a second rail disposed at a second predefined distance with respect to the central axis. The mounting arrangement further includes a second pair of rails disposed between the first plate and the second plate proximal to a second peripheral edge of each of the first plate and the second plate. The second peripheral edge is opposite to the first peripheral edge. The second pair of rails includes a third rail disposed at a third predefined distance with respect to the central axis. The third predefined distance is equal to the first predefined. distance. The second pair of rails further includes a fourth rail disposed at a fourth predefined distance with respect to the central axis. The fourth predefined distance is equal to the second predefined distance.

Other features and aspects of this disclosure will be apparent from the following description and the accompanying drawings.

### BRIEF DESCRIPTION OF THE DRAWINGS

FIG. 1 is a perspective view of a seat of a machine;

FIG. 2 is a perspective view of a mounting arrangement used for coupling the seat to a floor panel of the machine;

FIG. 3 is an exploded view of the mounting arrangement of FIG. 2; and

FIG. 4 is a front view of a first plate of the mounting arrangement having a first pair of rails and a second pair of rails disposed thereon.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in singular may also be construed to relate to the plural and vice-versa without limiting the scope of the disclosure to the exact number or type of such elements unless set forth explicitly in the appended claim.

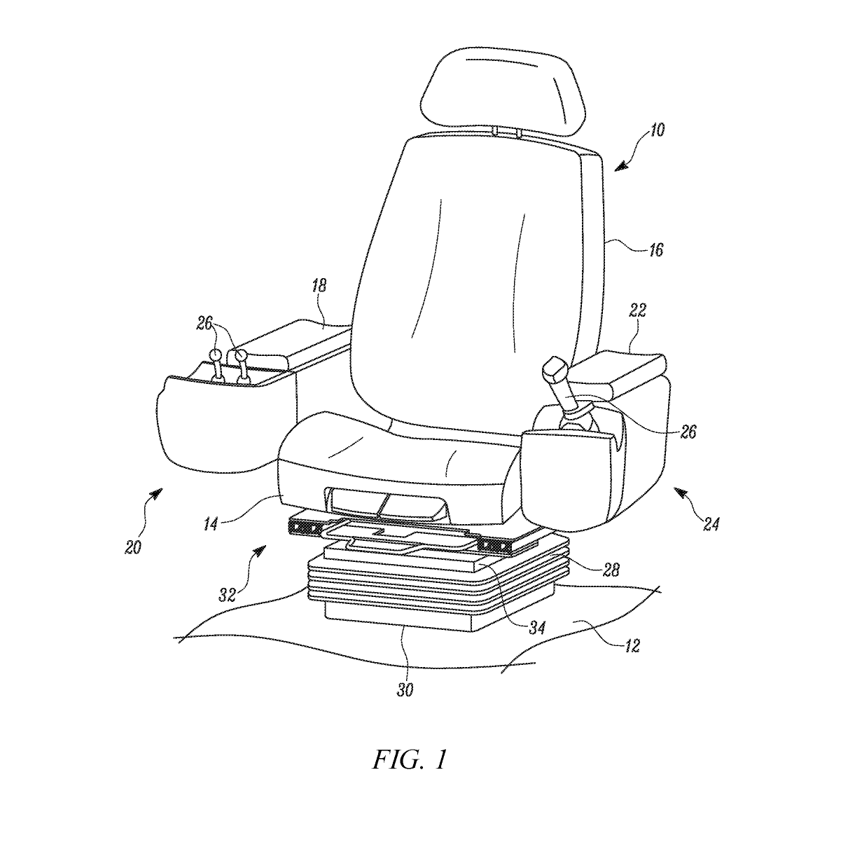

Referring to FIG. 1, a perspective view of a seat 10 disposed within an operator cabin of a machine (not shown) is illustrated. In an example, the machine may be a loader used to load or unload material in construction sites. In other examples, the machine may be, but not limited to, a mining truck, a material handler, or a wheeled dozer, The machine may further be associated with any industry including, but not limited to, transportation, construction, agriculture, forestry, power generation, and material handling. The machine includes an engine (not shown) for providing a motive power to the machine and a frame (not shown) for supporting various components, such as the operator cabin and an implement system. The operator cabin includes an operator interface (not shown), which may include one or more input devices, such as an accelerator, a braking pedal, a steering, and a display device, for controlling an operation of the machine.

The operator cabin further includes the seat 10 mounted on a floor panel 12 thereof. The seat 10 includes a seat pan 14, a seat back 16 coupled to the seat pan 14, a first armrest assembly 18 disposed at a first side 20 of the seat pan 14, and a second armrest assembly 22 disposed at a second side 24 of the seat pan 14. The seat 10 further includes multiple control devices 26 that are placed within the first armrest assembly 18 and the second armrest assembly 22 of the seat 10. The multiple control devices 26 are used for controlling operation of the implement system of the machine. The seat pan 14 of the seat 10 is coupled to a support member 28, which in turn is mounted on the floor panel 12 of the operator cabin using fastening members (not shown). More specifically, the support member 28 includes a first end 30 coupled to the floor panel 12 using the fastening members. The support member 28 acts as a suspension system that may prevent transferring of vibrations and/or shocks from the floor panel 12 to the seat pan 14 of the seat 10 during operation of the machine. The seat 10 further includes a mounting arrangement 32 that is used for coupling the seat 10 to the support member 28. More specifically, the mounting arrangement 32 is used for coupling a second end 34 of the support member 28 with the seat pan 14 of the seat 10.

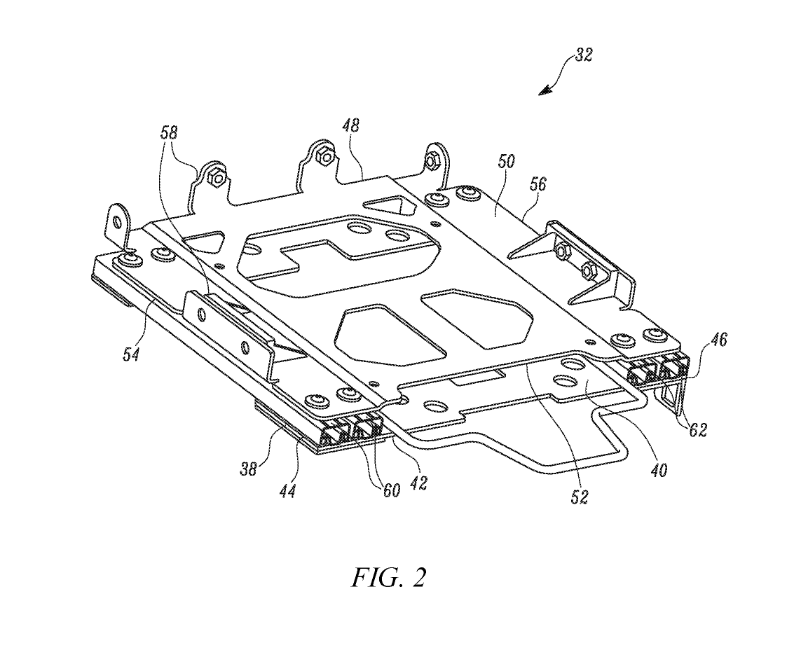

Referring to FIG. 2, a perspective view of the mounting arrangement 32 is illustrated. The mounting arrangement 32 includes a first plate 38 coupled to the second end 34 of the support member 28. The first plate 38 is fastened to the support member 28 using fastening members (not shown). The first plate 38 includes a top surface 40 and a bottom surface 42 contacting with the second end 34 of the support member 28. The first plate 38 has a first peripheral edge 44 and a second peripheral edge 46 opposite to the first peripheral edge 44. The first peripheral edge 44 of the first plate 38 is positioned at the first side 20 of the seat pan 14 and the second peripheral edge 46 of the first plate 38 is positioned at the second side 24 of the seat pan 14. A distance between the first peripheral edge 44 and the second peripheral edge 46 of the first plate 38 defines a width for the first plate 38.

The mounting arrangement 32 further includes a second plate 48 slidably coupled to the first plate 38, The second plate 48 includes a top surface 50 facing towards the seat pan 14 and a bottom surface 52 facing towards the top surface 40 of the first plate 38. The second plate 48 has a first peripheral edge 54 aligned with the first peripheral edge 44 of the first plate 38 and a second peripheral edge 56 aligned with the second peripheral edge 46 of the first plate 38. A distance between the first peripheral edge 54 and the second peripheral edge 56 of the second plate 48 defines a width for the second plate 48. The width of the first plate 38 and the width of the second plate 48 are equal. The second plate 48 further includes a plurality of mounting members 58 coupled to the seat pan 14 of the seat 10.

The mounting arrangement 32 further includes a first pair of rails 60 disposed between the first plate 38 and the second plate 48. The first pair of rails 60 is located proximal to the first peripheral edges 44 and 54 of the first plate 38 and the second plate 48, respectively, The mounting arrangement 32 further includes a second pair of rails 62 disposed between the first plate 38 and the second plate 48. The second pair of rails 62 is located proximal to the second peripheral edges 46 and 56 of the first plate 38 and the second plate 48, respectively. More specifically, the top surface 40 of the first plate 38 and the bottom surface 52 of the second plate 48 are coupled to the first pair of rails 60 and the second pair of rails 62. The first pair of rails 60 and the second pair of rails 62 facilitate movement of the seat 10 in a forward and a backward direction.

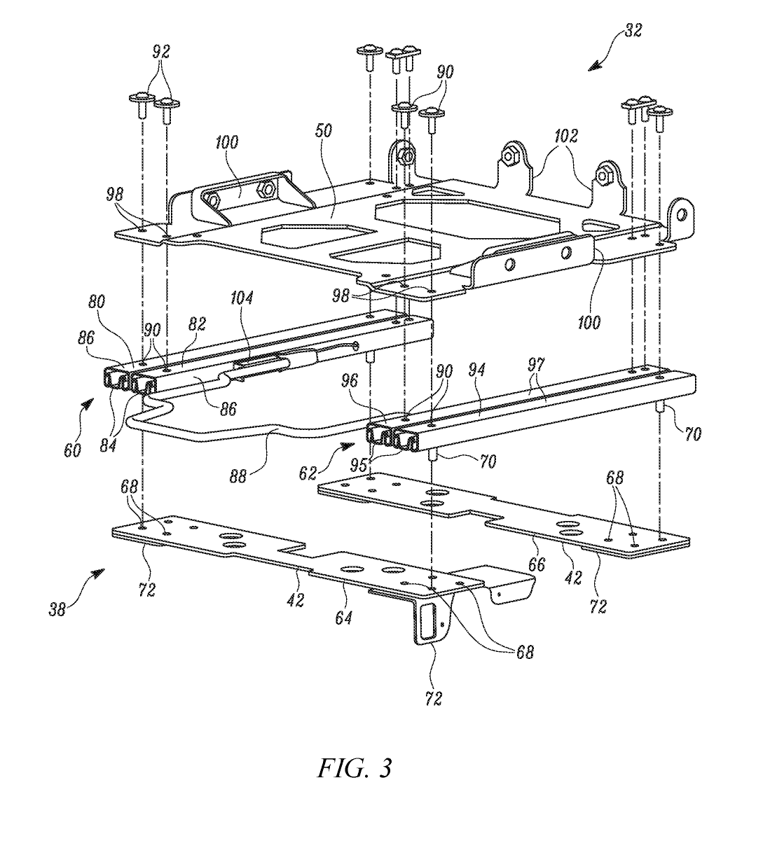

Referring to FIG. 3, an exploded view of the mounting arrangement 32 is illustrated. The first plate 38 is a multi-piece assembly having a first support plate 64 and a second support plate 66 spaced apart from the first support plate 64. In an example, the first plate 38 may be integrally formed as a single component. The first support plate 64 and the second support plate 66 include multiple through-holes 68 to receive a plurality of first fastening members 70 therethrough. The plurality of first fastening members 70 couples the first pair of rails 60 and the second pair of rails 62 with the first support plate 64 and the second support plate 66. Further, each of the first support plate 64 and the second support plate 66 includes a plurality of coupling members 72 coupled to the second end 34 of the support member 28. The plurality of coupling members 72. is disposed on the bottom surface 42 of the first support plate 64 and the second support plate 66. The plurality of coupling members 72 further includes one or more holes (not shown) aligned with the multiple through-holes 68 of the first support plate 64 and the second support plate 66, such that the plurality of first fastening members 70 is received therethrough to couple the first pair of rails 60 and the second pair of rails 62 with the first support plate 64 and the second support plate 66. In an example, the plurality of coupling members 72 may be welded to the first support plate 64 and the second support plate 66.

The first pair of rails 60 includes a first rail 80 and a second rail 82 disposed proximal to the first peripheral edges 44 and 54 of the first plate 38 and the second plate 48, respectively. The second rail 82 is located adjacent to the first rail 80. The first rail 80 and the second rail 82 facilitate movement of the seat 10 in the forward or backward directions. Each of the first rail 80 and the second rail 82 includes a first sliding member 84 and a second sliding member 86 slidably disposed on the first sliding member 84. A handle 88 of the seat 10 is coupled to the second sliding member 86. In an example, the handle 88 may be fastened to the second sliding member 86. The handle 88 of the seat 10 enables the operator of the machine to move the seat 10 in the forward or backward direction. The first sliding member 84 includes a set of through-holes (not shown) to receive the plurality of first fastening members 70. More specifically, the plurality of first fastening members 70 couples the first sliding member 84 with the first support plate 64 and the second support plate 66. The second sliding member 86 includes a set of through-holes 90 to receive a plurality of second fastening members 92. The plurality of second fastening members 92 aids in coupling the second plate 48 with the first pair of rails 60 and the second pair of rails 62.

The second pair of rails 62 includes a third rail 94 and a fourth rail 96 disposed proximal to the second peripheral edges 46 and 56 of the first plate 38 and the second plate 48, respectively. The fourth rail 96 is located adjacent to the third rail 94. The third rail 94 and the fourth rail 96 facilitate movement of the seat 10 in the forward or backward directions. Each of the third rail 94 and the fourth rail 96 includes a third sliding member 95 and a fourth sliding member 97 slidably disposed on the third sliding member 95. Further, the third sliding. member 95 includes a set of through-holes (not shown) to receive the plurality of first fastening members 70. More specifically, the plurality of first fastening members 70 couples the third sliding members 95 with the first support plate 64 and the second support plate 66. The fourth sliding member 97 includes a set of through-holes 90 to receive the plurality of second fastening members 92. It may be understood that construction of the first sliding member 84 and the second sliding member 86 explained with reference to each of the first rail 80 and the second rail 82 is similar to the construction of the third sliding member 95 and the fourth sliding member 97 of each of the third rail 94 and the fourth rail 96. Hence, for the sake of brevity, the construction of the third sliding member 95 and the fourth sliding member 97 are not explained in detail.

The second plate 48 further includes multiple through-holes 98 extending between the top surface 50 and the bottom surface 52 of the second plate 48. The multiple through-holes 98 of the second plate 48 are aligned with the set of through-holes 90 of the second sliding member 86, such that the plurality of second fastening members 92 is received therethrough, More specifically, the plurality of second fastening members 92 couples the second sliding member 86 of each of the first pair of rails 60 and the second pair of rails 62 with the second plate 48. The second plate 48 includes the plurality of mounting members 58 extending from the top surface 50 thereof. The plurality of mounting members 58 includes a set of first mounting members 100 and a set of second mounting members 102. The set of first mounting members 100 is located on the top surface 50 of the second plate 48 and is used for coupling with the first side 20 and the second side 24 of the seat pan 14. In one example, the set of first mounting members 100 may be provided to fasten the seat pan 14 with the second plate 48. In another example, the set of first mounting members 100 may be coupled with the first armrest assembly 18 and the second armrest assembly 22 of the seat 10. The set of second mounting members 102 is also located on the top surface 50 of the second plate 48. The set of second mounting members 102 assists in coupling of the seat pan 14 with the second plate 48. In an example, the set of second mounting members 102 may be fastened to the seat pan 14 with the second plate 48 via bolts. The second sliding member 86 of each of the second rail 82 and the fourth rail 96 includes a coupling member 104. The coupling member 104 is welded to the second sliding member 86 of each of the second rail 82 and the fourth rail 96. The coupling member 104 is used for coupling the handle 88 with the second rail 82 of the first pair of rails 60 and the fourth rail 96 of the second pair of rails 62. The second sliding member 86 and the fourth sliding member 97 moves to the forward direction and the backward direction based on an input received by the handle 88 from the operator.

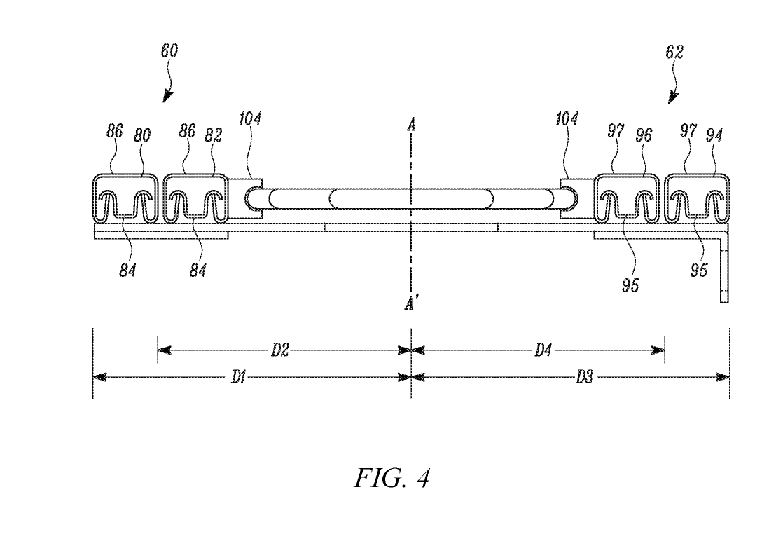

Referring to FIG. 4, a front view of the first plate 38 of the mounting arrangement 32 having the first pair of rails 60 and the second pair of rails 62 is illustrated. As described earlier, the first pair of rails 60 includes the first rail 80, which is disposed at a first predefined distance ‘D1’ with respect to a central axis A-A′ of the seat 10. Also, the second rail 82 of the first pair of rails 60 is disposed at a second predefined distance ‘D2’ with respect to the central axis A-A′. In addition, a distance between the first rail 80 and the second rail 82 is predefined. The third rail 94 is disposed at a third predefined distance ‘D3’ with respect to the central axis A-A′. The third predefined distance ‘D3’ of the third rail 94 is equal to the first predefined distance ‘D1’ of the first rail 80. The fourth rail 96 is disposed at a fourth predefined distance with respect to the central axis A-A′. The fourth predefined distance ‘D4’ of the fourth rail 96 is equal to the second predefined distance ‘D2’ of the second rail 82. Further, a distance between the third rail 94 and the fourth rail 96 is predefined. The predefined distance defined between the first rail 80 and the second rail 82 is equal to the predefined distance defined between the third rail 94 and the fourth rail 96. In addition, since the first predefined distance ‘D1’ of the first rail 80 and the third predefined distance ‘D3’ of the third rail 94 are equal, and the second predefined distance ‘D2’ of the second rail 82 and the fourth predefined distance ‘D4’ of the fourth rail 96 are equal, load acting on the mounting arrangement 32 is distributed evenly between the first pair of rails 60 and the second pair of rails 62.

### INDUSTRIAL APPLICABILITY

The present disclosure relates to the mounting arrangement 32 for the seat 10 of the machine. As described earlier, the first pair of rails 60 and the second pair of rails 62 are located at equal distances from the central axis A-A′. More specifically, the first predefined distance ‘DI’ is equal to the third predefined distance ‘D3’ and the second predefined distance ‘D2’ is equal to the fourth predefined distance ‘D4’. Owing to such configuration, load is distributed evenly on the first pair of rails 60 and the second pair of rails 62, thereby minimizing possibility of premature failure of the components of the mounting arrangement 32.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A mounting arrangement for a seat of a machine, the mounting arrangement comprising:
a first plate adapted to couple to a support member of the seat, the support member mounted on a floor panel of the machine;
a second plate slidably coupled to the first plate, the second plate including a plurality of mounting members adapted to couple to a seat pan and multiple control devices disposed adjacent to the seat pan;
a first pair of rails disposed between the first plate and the second plate proximal to a first peripheral edge of each of the first plate and the second plate, the first pair of rails including:
a first rail disposed at a first predefined distance with respect to a central axis of the seat; and
a second rail disposed at a second predefined distance with respect to the central axis; and
a second pair of rails disposed between the first plate and the second plate proximal to a second peripheral edge of each of the first plate and the second plate, wherein the second peripheral edge is opposite to the first peripheral edge, the second pair of rails including:
a third rail disposed at a third predefined distance with respect to the central axis, the third predefined distance is equal to the first predefined distance; and
a fourth rail disposed at a fourth predefined distance with respect to the central axis, the fourth predefined distance is equal to the second predefined distance.
